(19) United States
(12) Patent Application Publication
(10) Pub. No.: US 2026/0359713 A1
(43) Pub. Date: Nov. 12, 2026

(54) LARGE LANGUAGE MODEL SOLUTION OPTIMIZATION IN MULTI-TENANT ENVIRONMENTS

(71) Applicant: Kyndryl, Inc., New York, NY (US)

(72) Inventors: Gail Camille Guerrero, Austin, TX (US); Umar Mohamed Iyoob Umar, Austin, TX (US); Li Long Chen, Beijing (CN); Viswanatha Krishnamurthy, Bengaluru (IN)

(21) Appl. No.: 19/202,077

(22) Filed: May 8, 2025

(51) Int. Cl. G06N 20/00

(52) U.S. Cl. CPC G06N 20/00

(57) ABSTRACT

Aspects of the disclosure include a computer-implemented method. The computer-implemented method includes: constructing, by a computing device, an initial LLM solution based on existing LLM solutions in a multi-tenant environment; evaluating, by a computing device, the initial LLM solution with conditions required by a client of the initial LLM solution; and optimizing, by a computing device, the initial LLM solution using a reinforcement learning model to meet the conditions required by the client.

### BACKGROUND

Aspects of the present invention relate generally to optimizing large language models and, more particularly, to systems and methods of optimizing large language model solutions in multi-tenant environments.

A large language model (LLM) is a type of artificial intelligence model. These models are trained on massive amounts of text data allowing them to learn patterns and relationships. These models can generate human-like text, translate languages, and answer questions, among other tasks. LLM s can be used in multi-tenant environments, which allows, for example, a single software application or infrastructure to serve multiple customers (or “tenants”) simultaneously, sharing resources like hardware and software, while maintaining data and configuration isolation.

### SUMMARY

In a first aspect of the invention, there is a computer-implemented method including: constructing, by a computing device, an initial LLM solution based on existing LLM solutions in a multi-tenant environment; evaluating, by a computing device, the initial LLM solution with conditions required by a client of the initial LLM solution; and optimizing, by a computing device, the initial LLM solution using a reinforcement learning model to meet the conditions required by the client.

In another aspect of the invention, there is a computer program product including one or more computer readable storage media having program instructions collectively stored on the one or more computer readable storage media. The program instructions are executable to: construct a large language model (LLM) solution using LLM solutions of existing tenants of a multi-tenant environment which are similarly situated to a client of the LLM solution; evaluate the LLM solution to determine that the LLM solution requires improvement; and iteratively refine the LLM solution using a reinforcement learning model to optimize a model, context and query of the LLM solution.

In another aspect of the invention, there is system including a processor, a computer readable memory, one or more computer readable storage media, and program instructions collectively stored on the one or more computer readable storage media. The program instructions are executable to: construct an initial LLM solution based on existing LLM solutions of similarly based tenants in a multi-tenant environment; iteratively refine the LLM solution using a reinforcement learning RL model to optimize the initial LLM solution; evaluate the output of the initial LLM solution against predefined objectives and requirements of a client of the initial LLM solution using a machine learning model; and further optimize the initial LLM solution by monitoring the optimized LLM solution such that when performance falls below a predetermined threshold, the RL model will refine a stack of the LLM solution.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the present invention.

FIG. 5 shows an example operation of a similarity model module as described with respect to FIG. 4 in accordance with aspects of the present invention.

FIG. 6 shows a representative exemplary method using a reinforcement learning (RL) model to optimize a large language model (LLM) solution in accordance with aspects of the present invention.

FIG. 7 shows a flowchart of an exemplary method in accordance with aspects of the present invention.

### DETAILED DESCRIPTION

Aspects of the present invention relate generally to optimizing large language models (LLMs) and, more particularly, to systems and methods of optimizing LLM solutions in multi-tenant environments. In more specific embodiments, the systems and methods of optimizing LLM solutions in the multi-tenant environment comprise adaptive and reinforcement learning (RL) based solutions which leverage dynamic, feedback-driven learning to enhance the accuracy, adaptability, and alignment of the LLM solution in the multi-tenant environment. In this way, it is now possible to optimize the performance of the LLM solutions in multi-tenant environments in various tasks, particularly those involving complex interactions and decision-making, or other predefined objectives and/or requirements of the client (e.g., more generally “conditions” of the client). The systems and methods described herein are also implemented as a computer program product.

Traditional machine learning (ML) operations (MLOps) have established methods for evaluating model performance, such as tweaking hyperparameters or trying different models to improve accuracy. However, multi-tenant environments present many different technical challenges to evaluate performance and improve the LLM solutions. For example, in multi-tenant generative artificial intelligence (AI) environments, customizing and/or optimizing the LLM solution is inefficient and unscalable, requiring significant manual intervention. The manual interventions are time-consuming, error-prone, and challenging to scale. Current solutions also fail to adjust prompts and optimize LLM solutions using specific client requirements, performance feedback, and/or regulatory compliance, resulting in suboptimal efficiency and quality of the LLM solutions. This leads to inconsistent performance and client dissatisfaction.

With these above noted technical problems, aspects of the present invention provide a technical feature (e.g., technical solution) with a practical application to address the technical problems. The practical application and technical solutions include, for example, providing tools to evaluate and optimize the performance of LLM solutions in the multi-tenant environment. Also, the technical solutions described herein facilitate seamless deployment of multi-tenant LLM solutions into production environments, in addition to providing a more efficient, scalable LLM solution that leverages deep reinforcement (DP) learning and iterative processes to adjust and optimize LLM prompts and solutions. As further described herein, these practical applications and technical solutions are well rooted in computer technology and cannot be performed in the human mind or by pen and paper.

By way of more specific examples, aspects of the present invention implement a comprehensive, iterative process that includes monitoring, data collection, evaluation, and deep reinforcement (RL) learning to ensure efficient, high-performing, and tailored LLM solutions that meet the unique needs of each client in a multi-tenant environment. In embodiments, each client may be a tenant in the multi-tenant environment.

As an example, aspects of the present invention use reinforcement learning (RL) models to optimize an entire stack of the LLM solution, including a base model, context, and query used for retrieval-augmented generation (RAG). Unlike existing RL solutions that focus solely on prompt optimization, aspects of the present invention consider all factors influencing the output of the LLM solution enabling holistic performance optimization. This comprehensive method ensures responses are relevant, accurate, contextually appropriate, and aligned with the intended use case, leading to more robust and efficient LLM solutions.

In addition, aspects of the present invention provide reward functions to ensure that the RL solutions evaluate and dynamically optimize the performance of the LLM solutions, balancing multiple predefined objectives/requirements and continually adapting to changing requirements tailored to the needs of the client. Moreover, aspects of the present invention use adaptive clustering techniques, including, e.g., Principal Component Analysis (PCA), K-means and Generative Adversarial Networks (GANs), to analyze client profiles with superior accuracy in handling data variability and multi-tenancy in the multi-tenant environment. By dynamically selecting the best adaptive clustering techniques based on data volume and tenant (e.g., client) needs, for example, it is possible to identify similarly situated clients and optimize an initial LLM prompt, enhancing efficiency and satisfaction in a multi-tenant environment. Also, aspects of the present invention utilize cross-tenant learning where insights and optimization from a model (e.g., LLM solution) of one tenant may be used to inform and improve the performance of LLM solutions for other similarly situated tenants (e.g., a client). In this way, aspects of the present invention continuously monitor model performance, with retraining of the LLM solutions using both existing and new data when necessary.

It should be understood that, to the extent implementations of the present invention collect, store, or employ personal information provided by, or obtained from, individuals (for example, personal information, business confidential information, etc.) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDA s).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

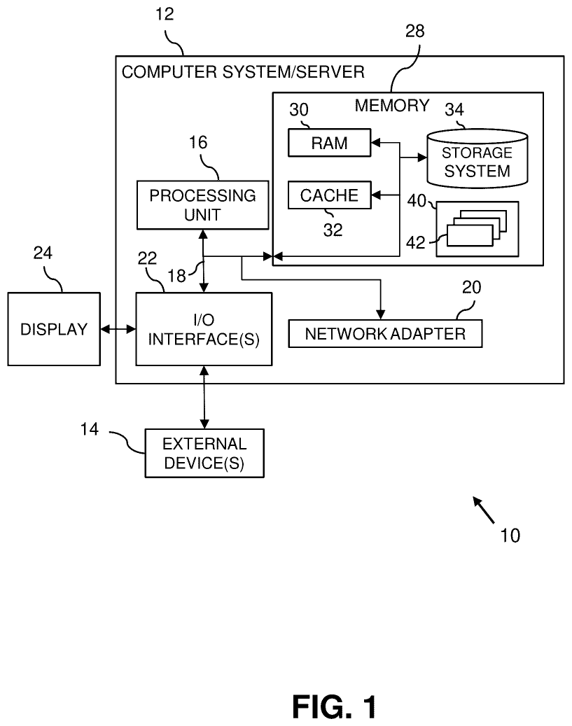

Referring now to FIG. 1, a schematic of an example of a cloud computing node is shown. Cloud computing node 10 is only one example of a suitable cloud computing node and is not intended to suggest any limitation as to the scope of use or functionality of embodiments of the present invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

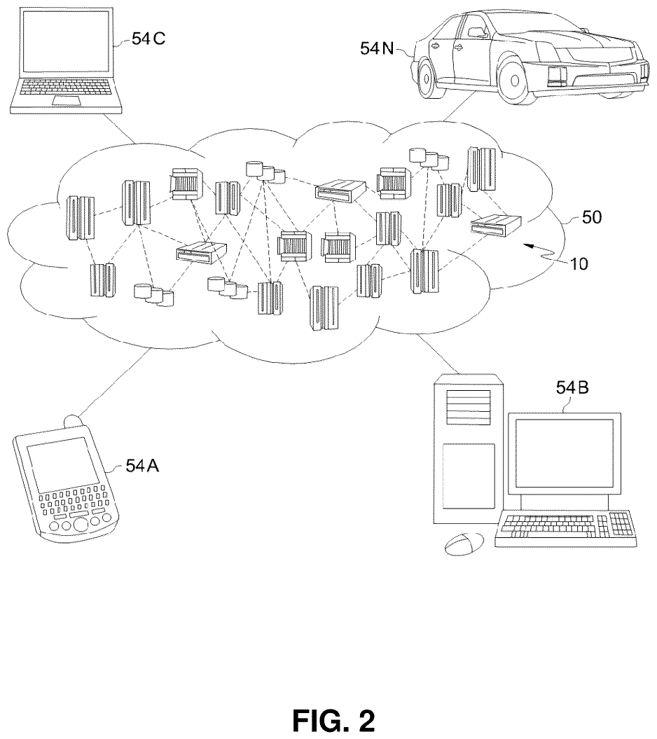

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

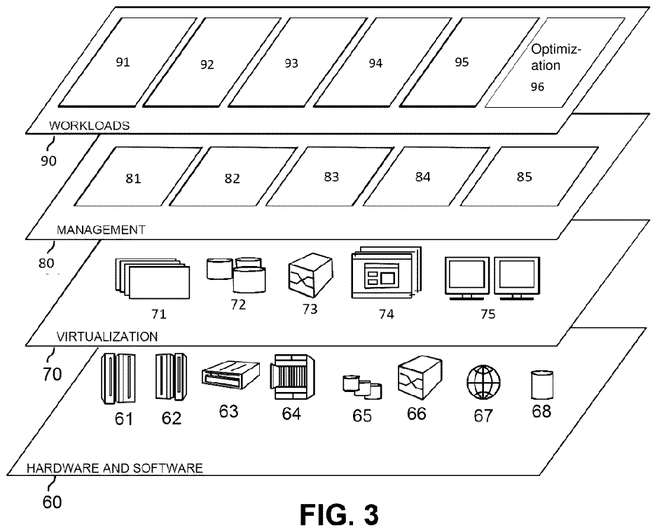

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the present invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and optimization 96.

Implementations of the present invention may include a computer system/server 12 of FIG. 1 in which one or more of the program modules 42 are configured to perform (or cause the computer system/server 12 to perform) one of more functions of the optimization 96 of FIG. 3. For example, the one or more of the program modules 42 may be configured to optimize performance of LLM solutions in multi-tenant environments.

More specifically, the one or more of the program modules 42 may be configured to: construct an initial LLM solution based on existing LLM solutions of similarly based tenants to the client (e.g., another tenant) in a multi-tenant environment; iteratively refine the LLM solution using reinforcement learning (RL) models, thereby optimizing the entire LLM solution; evaluate the output of the initial LLM solution against the predefined objectives and requirements of the client using a separate AI/LLM models; and continuously monitoring the LLM solution such that when performance falls below a predetermined threshold, the LLM solution can be optimized by repeating the cycle, starting with a new initial LLM solution using the existing and new data, and LLM solutions of other clients, etc.

In embodiments of the present invention, the RL models optimize the entire stack of the LLM solution, including the base model, context, and query used for retrieval-augmented generation (RAG). The RL model dynamically evaluates and optimizes the performance of the LLM solution, balancing multiple objectives and continually adapting to changing requirements to deliver the best possible assistance tailored to the needs of the client, thereby considering all factors influencing the output of the LLM solution and enabling a holistic performance optimization. This comprehensive method ensures responses are relevant, accurate, contextually appropriate, and aligned with the intended use case, leading to more robust and efficient LLM solution deployments. In addition, in aspects of the present invention, cross-tenant learning is implemented where insights and optimizations from a model or models of one tenant of the multi-tenant environment are used to improve the performance of the model or models for other tenants 9 e.g., client) of the multi-tenant environment with similar objectives and/or needs. Thus, implementation of the present invention leverages cross-tenant data which enhances model accuracy and efficiency, promoting knowledge sharing while maintaining data privacy and security.

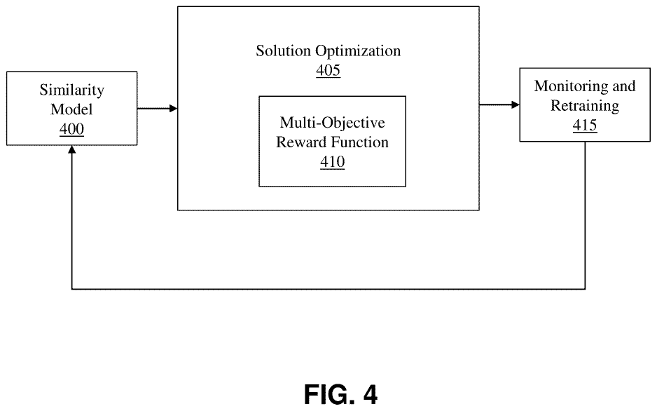

FIG. 4 shows a block diagram of an exemplary environment in accordance with aspects of the present invention. In embodiments, the different modules shown in FIG. 4 may comprise one or more program modules such as program module 42 described with respect to FIG. 1. The different modules may include additional or fewer modules than those shown in FIG. 4. In embodiments of the present invention, the separate modules may be integrated into a single module. Additionally, or alternatively, a single module may be implemented as multiple modules. Moreover, the quantity of modules and/or networks in the environment is not limited to what is shown in FIG. 4. Accordingly, in practice, the environment may include additional modules and/or networks; fewer devices and/or modules; different modules and/or modules; or differently arranged devices and/or networks than illustrated in FIG. 4. The use of modules in FIG. 4 ensures robust, efficient, and high-performing LLM solution deployments.

More specifically, the different modules shown in FIG. 4 include a Similarity Model module 400, a Solution Optimization module 405 with a Multi-Objective Reward Function submodule 410, and a Monitoring and Retraining module 415. The Multi-Objective Reward Function module 410 may be a submodule of the Solution Optimization module 405 or a separate, standalone module.

The Similarity Model module 400 may be an Adaptive Customer Similarity Model that, when onboarding a new client into the multi-tenant environment, constructs an initial LLM solution based on existing LLM solutions of similarly situated tenants within the multi-tenant environment. In embodiments, the Similarity Model module 400 may use, for example, a machine learning (ML) model and/or a deep learning (DL) model to learn patterns and relationship between client data (e.g., business requirements) and LLM solutions to construct the appropriate, initial LLM solution based on the similar features.

The Solution Optimization module 405 may be an RL-based LLM Solution Optimization module. The Solution Optimization module 405 will iteratively refine the LLM solution using an RL solution, optimizing the entire LLM solution, including the base model, context, and query used for retrieval-augmented generation (RAG).

By way of an example, the RL solution may be, for example, a proximal policy optimization method; although other deep leaning RLs are also contemplated herein to optimize the LLM solution. The proximal policy optimization (PPO) is a reinforcement learning algorithm that improves upon Trust Region Policy Optimization (TRPO) by using a clipped surrogate objective function. PPO aims to find the best policy by balancing the need to improve performance with the need to keep the policy updates stable, preventing large swings in the policy that can lead to unstable training.

The RL solution may include a state space and an action space. The state space is representative of items used in the generation of the initial LLM solution; whereas the action space may include items which are used to further refine or optimize the LLM solution by updating the state space. The state space items may include, for example, any combination of: tokens used in a current prompt for the current LLM solution; a base LLM model or a fine-tuned model(s); instructions provided in the prompt template used in the LLM solution; a current RAG method and query used in the LLM solution; example outputs (e.g., one shot, few shot, hybrid, etc.) of the current or initial LLM solution; and, if any, guardrails, compliance and governance issues used with the current or initial LLM solution. Guardrails may include, for example, checks for bias, and compliance may be, for example, checking that confidential or proprietary client information is not exposed, e.g., exclude personal information as an output. Governance may include any information or rules which govern the operations of the client. The LLM solution may use any combination of the state space items, any of which may be changed to optimize the LLM solution as needed.

The state space of the RL may be changed using action space items in the RL model. The action space items may be selected using, for example, epsilon greedy strategy or softmax sampling; although other methods are contemplated herein. The epsilon greedy strategy is a method used in reinforcement learning to balance exploration and exploitation in decision-making, which involves choosing the action with the highest estimated value (exploitation) with a certain probability (1-epsilon), and choosing a random action (exploration) with the remaining probability (epsilon). Softmax is used to convert a vector of numbers into a probability distribution, especially in multi-class classification problems.

The action space items may include, for example: prompt and instructions, e.g., changing tokens in the base model or fine-tuned LL M vocabulary; all possible base models or fine-tuned models including, for example, all data points and combinations of data points available to provide the LLM solution as example outputs for fine-tuning; and/or RAG information including, for example, all possible queries to retrieve context from the database. So, for a deployment of the optimized LLM solution, the above action space items can be used to further define the optimized LLM solution, i.e., (i) proper base models, (ii) fine-tuned models, (iii) prompt template and instructions for the LLM, (iv) context or RAG context, and query and/or method used to retrieve information from vector database, in addition to (v) guardrails for safety, compliance, and governance, amongst other feature.

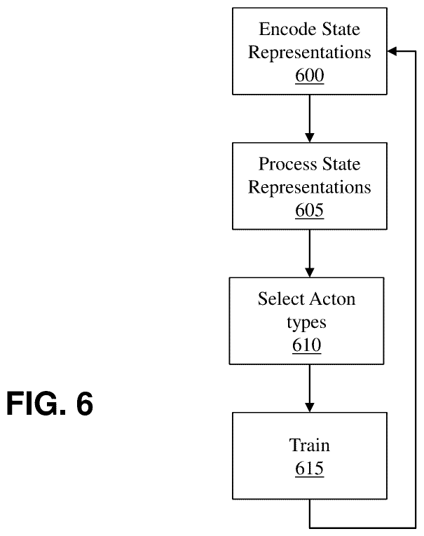

The Multi-Objective Reward Function module 410 may provide an adaptive and multi-objective reward function. For example, the output of the initial LLM solution will be evaluated against business objectives and requirements of the client using a separate LLM solution. The evaluation will result in evaluation scores used as rewards and adaptively balanced for the RL solutions that will iteratively update the LLM solution until the solutions meet the business requirements and objectives defined by the client. Examples of business requirements and/or objective may include target advertisements for a specific customer base, sales goals, protection of confidential or proprietary information, etc. The use of rewards are further described in more detail with respect to FIG. 6.

The Monitoring and Retraining module 415 may be deployed using a cross-tenant learning module which can use LLM solutions and items of similarly situated tenants in the multi-tenant environment. In embodiments, the Monitoring and Retraining module 415 will continuously monitor the performance of the LLM solution, and when the performance falls below a predetermined threshold, the entire cycle using modules 400-415 will be repeated, starting with a new initial LLM solution constructed by the Similarity Model module 400 using any new client data, in addition to LLM solutions of other tenants of the multi-tenant environment. The predetermined threshold (e.g., same rewards threshold) may be used in an iterative solution refinement process, and/or a manual flag by the user indicating that improvement is needed, at which point a description of the desired improvement to the business requirements is requested and added. In this way, aspects of the present invention will use cross-tenant learning within the multi-tenant environment to optimize the LLM solution.

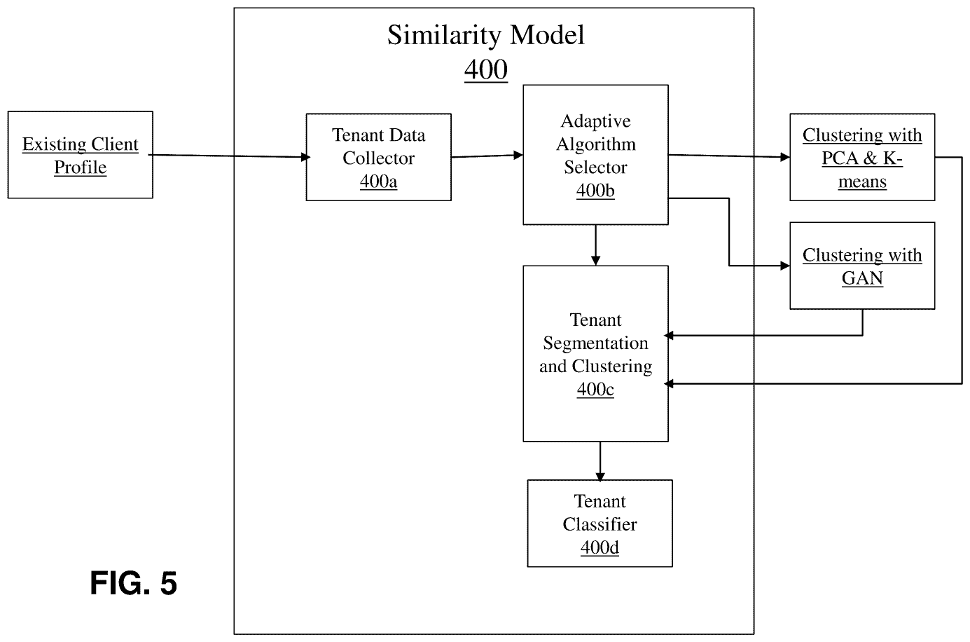

FIG. 5 shows an example operation of the Similarity Model module 400 of FIG. 4. In particular, the Similarity Model module 400 may be implemented as an Adaptive Customer Analysis Framework Model which includes different submodules including, for example, a Tenant Data Collector module 400a, an Adaptive Algorithm Selector module 400b, a Tenant Segmentation and Clustering module 400c, and a Tenant Classifier module 400d. In accordance with aspects of the present invention, for onboarding purposes, the Tenant Data Collector module 400a collects data from the client such as an existing profile data. The existing profile data may include static data and dynamic data. The static data may include, e.g., industry type, company size, objectives of the client, and branding guidelines, etc. The dynamic data may include, for example, interactions of the client, behaviors of the client, feedback from client, etc.

The data obtained from the Adaptive Customer Similarity Model module 400a may be input to the Adaptive Algorithm Selector module 400b. The Adaptive Algorithm Selector module 400b will select a specific adaptive clustering technique using the input data of the Tenant Data Collector module 400a. The selection of the specific adaptive clustering techniques may be based on an amount of data (e.g., volume of data) obtained from the Tenant Data Collector module 400a and needs of the client. The specific adaptive clustering techniques may be, for example, Principal Component Analysis (PCA), K-means and/or Generative Adversarial Networks (GANs), which are used to analyze client profiles with superior accuracy in handling data variability and multi-tenancy.

In embodiments of the present invention, the Adaptive Algorithm Selector module 400b may select different adaptive clustering techniques based on the volume (e.g., amount) of data received from the client and needs of the client. For example, the PCA may be used for clients with smaller volumes of data; whereas the PCA may be used for clients with a larger volumes of data. In any of these scenarios, though, the adaptive clustering techniques will use the data of the client to analyze with respective data of other clients (i.e., tenants of the multi-tenant environment) to cluster and segment the clients based on similarities within the data, e.g., cluster similar clients together based on the similarity of their data.

K-means clustering may be used in machine learning for unsupervised data grouping. K-means aims to partition a dataset into k distinct, non-overlapping clusters, where each data point belongs to only one cluster. The K-means iteratively assigns data points to the nearest cluster centroid and then recalculates the centroid as the mean of all points in that cluster. This process continues until the cluster assignments stabilize.

The output of the adaptive clustering techniques can be input to the Tenant Segmentation and Clustering module 400c. In embodiments, the Tenant Segmentation and Clustering module 400c may be a database used to store the clustering and segmentation data obtained from the different adaptive clustering techniques.

The Tenant Classifier module 400d will use the information from the Tenant Segmentation and Clustering module 400c to classify the client(s). The classification may be based on similarity of client (e.g., a new tenant within the within the multi-tenant environment) and existing tenants within the multi-tenant environment, for example. Illustratively, the Tenant Classifier module 400d can classify the clients based on industry, business objectives, business needs, types of projects, size of client, location of client, etc. By using the classification of different clients, the Adaptive Customer Similarity Model module 400 can find the optimal, initial LLM solution for the client based on an LLM solution used for other, similarly situated tenants within the multi-tenant environment. If there are no similar tenants, though, the Adaptive Algorithm Selector module 400b may simply select a basic LLM solution as a starting point based on the clients requirements and objectives.

FIG. 6 shows a representative exemplary method using a RL model to optimize the entire stack of the LLM solution in accordance with aspects of the present invention. More specifically, FIG. 6 shows a flow using an RL solution using an iterative process to optimize the LL M solution for a particular client. Steps of the method may be carried out in the environment of FIG. 3.

Referring to FIG. 6, at step 600, state representations (e.g., state action items) can be encoded at the input layer of a neural network (e.g., PPO or other deep RL). At step 605, the neural network may be used to process the state representations and produce a distribution of actions based on an output of the network. The distribution of actions may include, e.g., action selection items, selected using, for example, epsilon greedy strategy or softmax sampling.

At step 610, the systems and methods would select the most beneficial action types to be used, e.g., action selection items, in order to optimize the LLM solution. The beneficial action types may be based on a reward system, in which a grading system may be used to grade or assign a reward to the action state items used, for example, in step 615. At step 615, the RL solution, e.g., PPO method, would use the output to further train the policy network, e.g., LLM solution, using the most beneficial outputs, e.g., actions with the highest rewards. The solution may be feedback into step 600 in an iterative process.

In embodiments, the rewards may be a grading system for the output at step 615. For example, the output is reinforced with rewards based on the quality of the output, e.g., closeness to a client business requirement. By way of illustration, when the output, e.g., action selection item, in FIG. 6, is not a good output, a lower reward would be provided such that the RL solution would not likely use the output to retain the LLM solution. Accordingly, the rewards are based on reinforcing certain behaviors and actions to take so that the output of the RL or the LLM solution can produce improved results.

In further embodiments of the present invention, contextual embedding reward functions may be used to train the network. The reward functions may be based on the similarity between context and prompt thereby indicating context relevance. Moreover, the reward function may be based on a similarity between the prompt and the response indicating response coherence. In more specific embodiments, the rewards may be, for example, any combination of: (i) contextual embedding rewards which are rewards based on a measure of relevance and coherence using embeddings (e.g., similarity between context and prompt (context relevance) or similarity between prompt and response (response coherence); (ii) output alignment rewards which are rewards aligned with business objectives (e.g., similarity between response and business objectives (business alignment); (iii) non-functional requirements rewards which are rewards based on importance of various components including, e.g., system performance, cost, and efficiency; (iv) adaptive reward scaling which dynamically adjust weighing of the rewards based on trends, feedback, objectives, coherence, informativeness, user satisfaction, etc.; and/or (v) multi-objective rewards which are rewards which balance relevance, informativeness, efficiency, and satisfaction. In embodiments, the multi-objective rewards may be based on an average similarity between context and LLM Ops stack components (model alignment).

In additional aspects of the present invention the following provides further functionality of the contextual embedding rewards, adaptive reward scaling and multi-objective reward functions.

Contextual Embedding Rewards: This reward includes understanding the prompt tokens, the base and fine-tuned models used, the specific instructions, the retrieval-augmented generation (RAG) methods, example outputs, and safety guardrails. This comprehensive approach ensures that the responses of the LLM solution are tailored and contextually accurate.

Adaptive Reward Scaling: This technique continuously adjusts the scaling factors of different reward components based on recent performance trends and user feedback. For example, during project deadlines, the systems and methods described herein might prioritize efficiency and quick response times. By dynamically scaling the rewards, the LLM solution remains sensitive to these changes and consistently delivers high-value outputs tailored to the current needs.

Multi-Objective Reward Functions: Responses should not only be relevant and informative but also efficient and satisfying to users. By employing multi-objective reward functions, improving one objective (like informativeness) will ensure that it is does not compromise another objective (e.g., efficiency). This approach considers all elements of the LLM Ops solution stack, from the base model and fine-tuned model to the RAG methods and guardrails, ensuring a balanced and optimal performance across all tasks.

By way of further example, the rewards may be calculated based on the following illustrative, non-limiting equation:

$$Reward = {β}_{cp} ( t ) \cdot Sim ( C , P ) + {β}_{pr} ( t ) \cdot Sim ( P , R ) + {β}_{bus} ( t ) \cdot Sim ( R , Bus ) + {β}_{nf} ( t ) \cdot NF + {β}_{stack} ( t ) \cdot AvgSim ( C , Stack ) + {\sum }_{i = 1}^{n} {β}_{{O}_{i}} ( t ) \cdot {O}_{i}$$

wherein:
Sim(C, P) represents a Similarity of Context and Prompt;
Sim(P, R) represents a Similarity of Prompt and Response;
Sim(R, Bus) represents Similarity of Response and Business Objectives;
NF represents a Nonfunctional Requirements reward value;
Sim(C, Stack) represents Similarity of Context and Stack components;
Oᵢ represents a score for i-th other feature;
Sim represents a similarity scoring function measuring how semantically close two elements are (ex., cosine similarity between embeddings);
C (Context) represents an input context or background information provided to the model to help the LLM interpret the prompt;
P (Prompt) represents the input text or query given to the LLM, which can be a simple question, a statement, or a more complex set of instructions to solicit a response;
R (Response) represents a final output or answer produced by the model based on the prompt;
Bus (Business Objectives) represents the desired business goals or priorities (ex., brand alignment, product emphasis, strategic focus);
NF (Nonfunctional Requirements) represents a score for nonfunctional criteria like latency, efficiency, and cost;
Stack (LLM Solution Stack Components) represents a components used in the LLM Solution stack, e.g., Base model, fine-tuned model, prompt, instructions, context or RAG query, example for output, etc.; and
Oi (Other Feature Scores) represents scores for additional optional features, such as coherence, informativeness, user satisfaction, safety, compliance, governance.

In Contextual Embedding Rewards: β_{cp}(t)×Sim(C, P) represents similarity between context and prompt and βₚᵣ(t) c Sim(P, R) represents similarity between prompt and response;

In Output Alignment Reward: β_{bus}(t)×Sim(R, Bus) represents similarity between response and business objectives;

In Nonfunctional Requirements Reward: β_{nf}(t)×NF represents rewards based on system performance, cost, efficiency, etc.;

In Adaptive Reward Scaling: β represents dynamically adjusted weights for all components;

In Multi-Objective Reward Functions: β_{stack}(t)×Avg Sim(C, Stack) represents average similarity between context and LLM Ops stack components;

For other feature scores: the sum of β_{Oi}(t)×Oi.

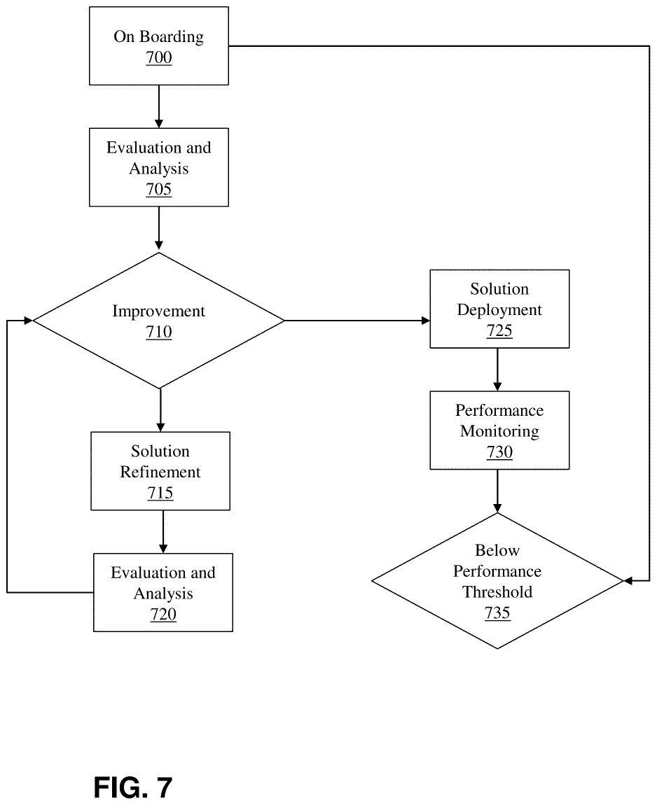

FIG. 7 shows a flowchart of an exemplary method in accordance with aspects of the present invention. Steps of the method may be carried out in the environment of FIG. 4 and are described with reference to elements depicted in FIG. 4.

At step 700, the processes begin the onboarding of a new client (e.g., tenant) within the multi-tenant environment. The onboarding of the new client, for example, may be implemented by the Similarity Model module 400 (Adaptive Customer Similarity Model) of FIG. 4. For example, the Similarity Model module 400 may construct an initial LLM solution based on existing LLM solutions of similar clients or tenants within the multi-tenant environment. Using ML/DL models, it is possible to learn patterns and relationships between client data/business requirements and an optimal LLM solution, and use this information to construct the appropriate LLM solution for the client based on the similar features.

At step 705, the processes herein will evaluate and analyze the LLM solution. This analysis may include reviewing the base model or fine-tuned model, prompt template and instructions for the LLM solution, context or RAG context, and query and/or method used to retrieve information from the database (one shot, few shot, semantic/similarity/hybrid search). The analysis may also review guardrails for safety, compliance, and governance, etc. It should be understood by those of skill in the art that other items or hyperparameters for the above factors can be defined for such analysis.

At step 710, a decision is made as to whether any improvements need to be made to the LLM solution. If not, the LLM solution can be deployed at step 725. If improvements are needed at step 710, the process continues to step 715.

At step 715, the processes may refine the LLM solution. In embodiments of the present invention, the refinement of the solution may be obtained by the Solution Optimization module 405 of FIG. 4. As described herein, the Solution Optimization 405 may be an RL-based LLM solution optimization in which the LLM solution is iteratively refined using an RL solution. This refinement may include, for example, the base model, context, and query used for retrieval-augmented generation (RAG), etc. as already described herein.

At step 720, the processes evaluate and analyze the refined LLM solution. In embodiments, this step may be similar to that of step 705. In addition, the processes of step 720 may implement a rewards function using the Multi-Objective Reward Function module 410 of FIG. 4 to evaluate the output of the initial LLM solution against the business objectives and requirements of the client. The evaluation scores (e.g., rewards) will be adaptively balanced for reinforcement learning and can be used to iteratively update the LLM solution until it meets the business requirements defined by the client. The processes can continue to step 720, where it is again determined if improvement is needed. If so, steps of 715 and 720 may be repeated, otherwise the optimized LLM solution will be deployed at step 725.

At step 730, the processes monitor the deployed LLM solution. For example, the deployed LLM solution may be monitored by the Monitoring and Retraining module 415 of FIG. 4. In embodiments of the present invention, the performance of the LLM solution may be continuously monitored, and when performance (e.g., output) falls below a certain threshold as determined at step 735, the processes will refresh the LLM solution by repeating the entire cycle beginning at step 700, e.g., starting with a new initial LLM solution constructed by the Similarity Model using the data and LLM solutions of the client and other clients similarly situation in the multi-tenant environment to enable cross-tenant learning.

Accordingly, the present invention provides enhanced efficiency and scalability by utilizing RL solutions to automatically tweak prompts for multi-tenant environments which will significantly reduce the need for manual intervention, enabling scalable and efficient customization of LLM solutions. The present invention also provides optimized customer experience, i.e., the client will never see deterioration in performance because the system will not require manual intervention to improve the LLM solution if performance falls below a predetermined threshold. Moreover, the present invention provides continuous improvement and customization monitoring and evaluation processes. This allows for ongoing optimization of the LLM solution, ensuring the LLM solution consistently meets evolving business requirements and maintains high performance.

In still additional embodiments, the present invention provides a computer-implemented method, via a network. In this case, a computer infrastructure, such as computer system/server 12 (FIG. 1), can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
constructing, by a computing device, an initial LLM solution based on existing LLM solutions in a multi-tenant environment;
evaluating, by a computing device, the initial LLM solution with conditions required by a client of the initial LLM solution; and
optimizing, by a computing device, the initial LLM solution using a reinforcement learning model to meet the conditions required by the client.

2. The computer-implemented method of claim 1, wherein the reinforcement learning model uses adaptive clustering techniques to analyze client profiles to optimize the initial LLM solution.

3. The computer-implemented method of claim 1, wherein the constructing of the initial LLM solution comprises using a learning model to learn relationships of data of one or more tenants in the multi-tenant environment and the optimized LLM solution for the client.

4. The computer-implemented method of claim 1, wherein the constructing of the initial LLM solution comprises using data of one or more tenants in the multi-tenant environment that are similar to the client.

5. The computer-implemented method of claim 1, wherein the reinforcement learning model optimizes a base model, context and query used for retrieval augmented generation (RAG).

6. The computer-implemented method of claim 1, further comprising:
deploying the optimized LLM solution; and
monitoring the deployed, optimized LLM solution to ensure the deployed, optimized LLM solution continues to meet the conditions required by the client.

7. The computer-implemented method of claim 6, further comprising determining whether a performance of the optimized LLM solution falls below a predefined threshold.

8. The computer-implemented method of claim 6, further comprising retraining the deployed, optimized LLM solution using cross-tenant learning in the multi-tenant environment.

9. The computer-implemented method of claim 1, wherein the reinforcement learning model continually adapts to changing requirements of the client to provide the optimized LLM solution.

10. The computer-implemented method of claim 1, further comprising using adaptive clustering techniques to analyze profiles in data variability in the multi-tenant environment and using the profiles in the data variability to optimize the initial LLM solution.

11. The computer-implemented method of claim 1, further comprising assigning rewards to balance factors used in the reinforcement learning model to optimize the initial LLM solution.

12. The computer-implemented method of claim 1, wherein the computing device includes software provided as a service in a cloud environment.

13. A computer program product comprising one or more computer readable storage media having program instructions collectively stored on the one or more computer readable storage media, the program instructions executable to:
construct a large language model (LLM) solution using LLM solutions of existing tenants of a multi-tenant environment which are similarly situated to a client of the LLM solution;
evaluate the LLM solution to determine that the LLM solution requires improvement; and
iteratively refine a stack of the LLM solution using a reinforcement learning model to optimize a model, context and query of the LLM solution.

14. The computer program product of claim 13, wherein the constructing of the LL M solution comprises using a base model.

15. The computer program product of claim 13, wherein refining of the stack of the LLM solution comprises an iterative processes wherein the reinforcement learning model continually adapts to changing requirements of the client.

16. The computer program product of claim 13, further comprising assigning rewards to balance factors used in the reinforcement learning model to optimize the LLM solution.

17. The computer program product of claim 13, wherein the iteratively refinement of the stack of the LLM solution comprises adaptive clustering of the client and the existing tenants of the multi-tenant environment, and classifying the client and the existing tenants based on similarities.

18. The computer program product of claim 13, wherein the model comprises a base model, and the query is used for retrieval-augmented generation (RAG).

19. A system comprising:
a processor, a computer readable memory, one or more computer readable storage media, and program instructions collectively stored on the one or more computer readable storage media, the program instructions executable to:
construct an initial LLM solution based on existing LLM solutions of similarly based tenants in a multi-tenant environment;
iteratively refine the LLM solution using a reinforcement learning RL model to optimize the initial LLM solution;
evaluate the output of the initial LLM solution against predefined objectives and requirements of a client of the initial LLM solution using a machine learning model; and
further optimize the initial LLM solution by monitoring the optimized LLM solution such that when performance falls below a predetermined threshold, the RL model will refine a stack of the LLM solution.

20. The system of claim 19, wherein the stack comprises a base model, context and query used for retrieval-augmented generation (RAG).
